(19) United States
(12) Patent Application Publication
(10) Pub. No.: US 2003/0156814 A1
(43) Pub. Date: Aug. 21, 2003

(54) Optical fiber block having semicircular grooves and method for same

(76) Inventors: Shin-Young Yoon, Suwon-shi (KR); Oh-Dal Kwon, Suwon-shi (KR)

Correspondence Address: CHA & REITER, 411 HACKENSACK AVE, 9TH FLOOR, HACKENSACK, NJ, 07601, US

(21) Appl. No.: 10/358,541

(22) Filed: Feb. 5, 2003

(30) Foreign Application Priority Data
Feb. 21, 2002 (KR) 2002-9269

(51) Int. Cl. G02B 6/00

(52) U.S. Cl. 385/137

(57) ABSTRACT

Disclosed is an optical fiber block defining semicircular grooves thereon, and a method of making it. The optical fiber block comprises: an optical fiber cable having at least one core; a block base, including a body portion defining at least one semicircular groove across a top surface thereon, the quantity of semicircular grooves corresponding to the quantity of cores to be seated therein, the quantity of semicircular grooves corresponding to the quantity of cores to be seated therein; an adhesive applied to the block body so as to cover the optical fiber cable and the top surface of the block body; and, a cover disposed on the block body applied with the adhesive.

### CLAIM OF PRIORITY

This application claims priority to an application entitled “Optical Fiber Block Having Semicircular Grooves,” filed in the Korean Intelletual Property Office on Feb. 21, 2002 and assigned Ser. No. 2002-9269, the contents of which are hereby incorporated by reference.

### BACKGROUND OF THE INVENTION

1. Field of the Invention

The present invention generally relates to an optical device. The invention particularly relates to an optical block having semicircular grooves.

2. Description of the Related Art

An optical fiber block functions as a main component for aligning an array of cores or strands of an optical fiber cable relative to an input or output terminal of a planar lightwave circuit (PLC) and then connecting them to each other. It is also one of the optical components that are used as an input/output terminal of an optical device such as a micro-optic device. Generally, such an optical fiber block including a block base and a cover is manufactured including the steps of:

1. seating an array of cores or strands of an optical fiber cable onto a plurality of V-shaped grooves which are formed on a top surface of the block base made of silicon, quartz, glass, or the like, each having a uniform pitch, depth, and length, wherein the array of cores or strands of the optical fiber cable is typically prepared by partially removing a sheath from the optical fiber cable;

2. covering the array of cores of the optical fiber cable with a cover having a plurality of V-shaped grooves which are formed on a bottom surface of the cover, each having a uniform pitch, depth, and length;

3. fixing the array of cores of the optical fiber cable, the block base, and the cover using an adhesive such as epoxy resin; and,

4. polishing an end face of the optical fiber block.

FIG. 1 is a cross-sectional view of an optical fiber block having V-shaped grooves according to the prior art. The optical fiber block comprises an optical fiber cable 150, a block base 110, and a cover 130.

The optical fiber cable 150 includes at least one core and at least one clad enclosing the core. Preferably eight cores and eight claddings are to be used. The core functions as a path to transmit at least one optical signal, while the clad functions to confine the optical signal within the core.

The block base 110 is made of silicon with eight V-shaped grooves 120 formed on a top surface thereof. The grooves 120 are arranged at a uniform pitch of 127 microns.

The cover 130 is made of glass, having an area approximate to that of the block base 110.

As an optical adhesive 140 applied to the block base on which the eight cores of the optical fiber cable 150 are seated, a thermosetting resin or an ultra-violet setting resin is commonly used because it is easy to use, it allows adjustment of the curing property, refractive index, and meets various desired characteristics.

Of the eight cores of the optical fiber cable 150 mounted in the optical fiber block 100, the inner six cores are stably mounted due to support from the adjacent cores on both sides. The two outer cores are supported by only one adjacent core making them mounted less stably than the other six. A problem arises when the grooves 120 have a smaller pitch than the diameter of the optical fiber core. The result is that the two outside cores have a tendency to be derailed from their corresponding grooves. These derailed cores are subjected to excessive stress by the cover and are broken or may cause the transmission properties of an optical signal to deteriorate.

In addition, the V-shaped grooves 120 have two side surfaces intersected with each other at a predetermined angle. The cores of the optical fiber cable 150 have a cylindrical shape. Therefore, when the cores of the optical fiber cable 150 come into contact with the V-shaped grooves 120, the contact area between the cores of the optical fiber cable 150 and the V-shaped grooves 120 is much smaller than the total surface area of the V-shaped grooves. Consequently, the contact areas are subjected to a high pressure concentration resulting in decreased reliability of the optical fiber cable 150.

### SUMMARY OF THE INVENTION

The present invention provides an optical fiber block defining semicircular grooves across a top surface in which at least one optical fiber cable can be mounted stably with improved reliability.

According to one embodiment of the present invention, an optical fiber block defining semicircular grooves thereon includes:

an optical fiber cable having at least one core;

a block base, including a body portion defining at least one semicircular groove across a top surface thereon, the quantity of semicircular grooves corresponding to the quantity of cores to be seated therein;

an adhesive applied to the block body so as to cover the optical fiber cable and the top surface of the block body; and,

a cover disposed on the block body to which the adhesive is applied.

In another embodiment of the invention, a method of making an optical fiber block with semicircular grooves thereon, is provided and includes the steps of:

providing an optical fiber cable having at least one core;

providing a block base including a block body and a support;

forming at least one semicircular groove on a top surface of the block body, the quantity of semicircular grooves corresponding to the quantity of cores to be seated therein;

applying an adhesive to the block body so as to cover the optical fiber cable and the top surface of the block base; and,

disposing a cover onto the block base to which the adhesive is applied.

### BRIEF DESCRIPTION OF THE DRAWINGS

FIG. 1 is a cross-sectional view of an optical fiber block having V-shaped grooves according to the prior art;

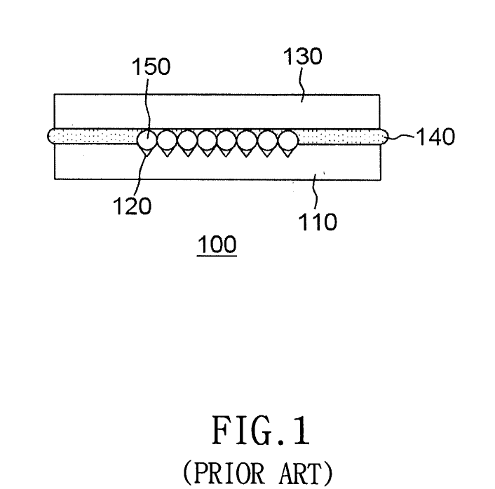

FIG. 2 is a perspective view of a block base defining semicircular grooves across a top surface according to one preferred embodiment of the present invention;

FIG. 3 is a cross-sectional view taken along the A-A axis of FIG. 2;

FIG. 4 is a perspective view of the assembled optical fiber block; and,

FIG. 5 is a cross-sectional view taken along the B-B axis of FIG. 4.

### DETAILED DESCRIPTION OF THE PREFERRED EMBODIMENT

In accordance with the present invention, a preferred embodiment of the present invention will be described in detail with reference to the accompanying drawings. In the drawings, the same element, although depicted in different drawings, will be designated by the same reference numeral or character. For the purposes of clarity and simplicity, a detailed description of known functions and configurations incorporated herein will be omitted as it may make the subject matter of the present invention unclear.

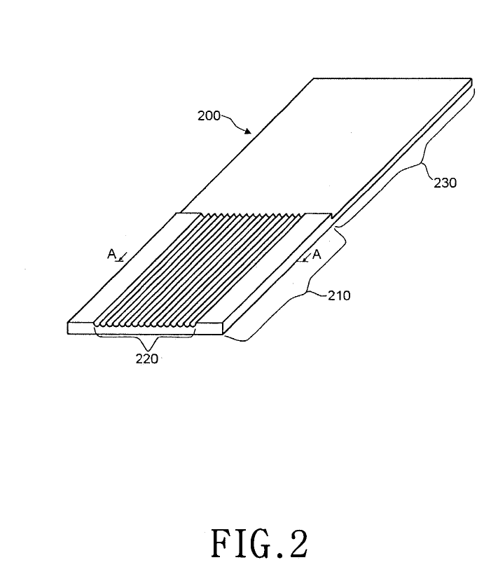

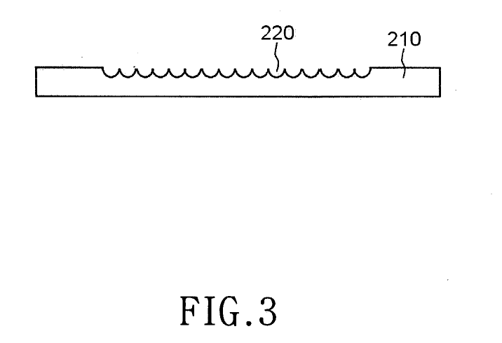

FIG. 2 is a perspective view of a block base having semicircular grooves according to one preferred embodiment of the present invention. FIG. 3 is a cross-sectional view taken along the A-A axis of FIG. 2.

The block base 200 includes a body 210 and a support 230 which are made of silicon.

The body 210 is formed with sixteen semicircular grooves 220 on a top surface thereof, which are arranged at a uniform pitch of 127 microns. Each of semicircular groove 220 is designed to have a radius approximate to that of each core of the optical fiber cable, so as to provide a maximum contact area between each core of the optical fiber cable and the body 210.

The support 230 extends from the body 210 by a predetermined length, having a thickness thinner than that of the body 210.

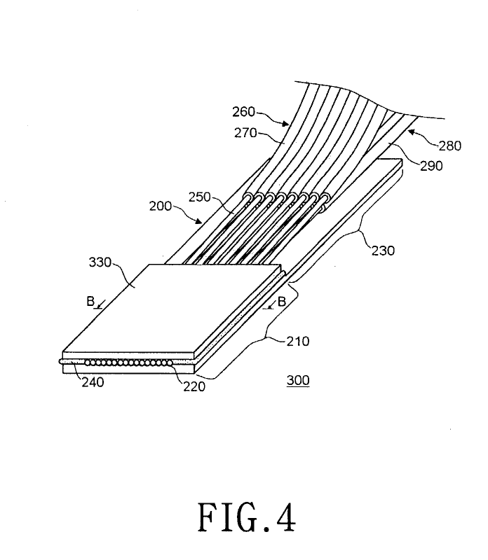

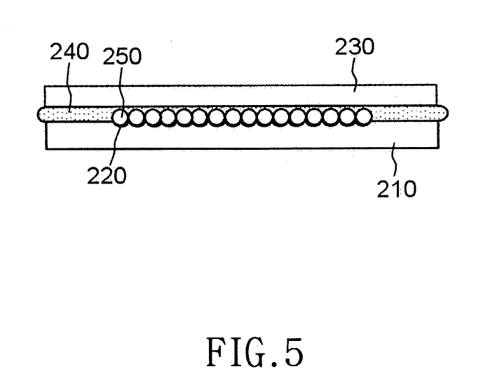

FIG. 4 is a perspective view of the assembled optical fiber block. FIG. 5 is a cross-sectional view taken along the B-B axis of FIG. 4. The optical fiber block 300 includes first and second ribbon-type optical fiber cables 260 and 280, a block base 200, and a cover 330.

The first and second ribbon-type optical fiber cables 260 and 280 are layered horizontally, and have their respective sheaths 270 and 290 removed over a predetermined length at the end. The cores 250 which are exposed by removal of the sheaths 270 and 290 from the optical fiber cables 260 and 280 have a diameter of 125 microns.

The block base 200 includes a body 210 provided with sixteen semicircular grooves 220 on a top surface thereof, and a support 230 extending from the body 210. The sixteen semicircular grooves 220 accommodate seating of up to sixteen cores 250.

The cover 330 is made of glass. Preferably, a flat glass plate having an area approximate to that of the body 210 is to be used as the cover 330.

For an optical adhesive 240 applied to the block base 200 on which the cores 250 of the optical fiber cable are seated, a thermosetting resin or an ultra-violet setting resin is used because it is easy to use, it allows adjustment of the curing property and refractive index, and it meets various desired characteristics. As described above, the present invention provides semicircular grooves 220 in the body 210 in which to seat the cores 250. Each core 250 is individually supported in its corresponding semicircular groove 220 and does not depend on stability from its adjacent cores 250 as in the prior art. This provides for a more stable support for the two outside cores that do not have support from the cores 250 on both sides. Consequently, this pattern will eliminate the problem of the two end cores 250 moving out of their grooves causing pressure from the cover 330 to break them or causing transmission properties of an optical signal to deteriorate.

Furthermore, as the contact area between the semicircular grooves 220 and the cores 250 is greater than that in a V-shaped groove 120 body 110, the resulting pressure on the contact surface is decreased. This increases the reliability of a fiber optic cable 150.

While the invention has been shown and described with reference to a preferred embodiment thereof, it will be understood by those skilled in the art that various changes in form and details may be made therein without departing from the spirit and scope of the invention as defined by the appended claims. Therefore, this invention is not to be unduly limited to the embodiment set forth herein, but it is to be defined by the appended claims and the equivalents thereof.

What is claimed is:

1. An optical fiber block having semicircular grooves thereon, comprising:
an optical fiber cable having at least one core;
a block base having at least one semicircular groove across a top surface thereon;
an adhesive applied to the block base so as to cover the optical fiber cable and the top surface of the block base; and,
a cover disposed on the block base to which the adhesive is applied.

2. The optical fiber block according to claim 1, wherein the block base further includes a body formed with at least one semicircular grove on a top surface thereof, and a support extending from the body having a thickness substantially thinner than that of the body.

3. The optical fiber block according to claim 2, wherein the body and the support are formed from silicon.

4. The optical fiber block according to claim 1, wherein the semicircular grooves are arranged at a uniform pitch.

5. The optical fiber block according to claim 4, wherein the uniform pitch is 127 microns.

6. The optical fiber block according to claim 1, wherein the radius of the semicircular grooves is substantially equal to the radius of the cores to be seated therein.

7. The optical fiber block according to claim 1, wherein the cover is made of glass.

8. The optical fiber block according to claim 1, wherein the cover is a flat glass plate having an area substantially equal to that of the body.

9. A method of making an optical fiber block defining semicircular grooves thereon, comprising the steps of:
providing an optical fiber cable having at least one core;
providing a block base including a block body and a support;
forming at least one semicircular groove on a top surface of the block body;
applying an adhesive to the block body to cover the optical fiber cable and the top surface of the block base; and,
disposing a cover onto the block base to which the adhesive is applied.

10. The method according to claim 9, wherein the step of forming at least one semicircular groove on a top surface of the block body further includes the steps of:
forming the semicircular grooves having a radius that is about the radius of the cores to be seated therein; and,
forming the semicircular grooves at a uniform pitch from one another.

11. The method according to claim 9, wherein the step of providing a block base including a block body and a support, further includes the step of forming the block body and support from silicon.

12. The method according to claim 9, wherein the step of disposing a cover onto the block base to which the adhesive is applied, further includes the step of making the cover from a flat glass plate having an area substantially equal to that of the body.
